(19) United States
(12) Patent Application Publication
(10) Pub. No.: US 2003/0110309 A1
(43) Pub. Date: Jun. 12, 2003

(54) Method for accessing user data, associated data processing installation, associated program and associated data structure

(75) Inventors: Dieter Hemkemeyer, Oelde (DE); Christian Klepp, Graz (AT); Christian Scheering, Bielefeld (DE); Markus Ollinnger, Graz (AT)

Correspondence Address: STAAS & HALSEY LLP, 700 11TH STREET, NW, SUITE 500, WASHINGTON, DC, 20001, US

(73) Assignee: Siemens AG, Munich (DE)

(21) Appl. No.: 10/268,087

(22) Filed: Oct. 10, 2002

(30) Foreign Application Priority Data
Oct. 10, 2001 (DE) 101 49 977.9

(51) Int. Cl. G06F 9/46

(52) U.S. Cl. 709/316; 709/330

(57) ABSTRACT

A central method is used to access a user identifier which denotes a user who is using or wishes to use an operating resource whose function is provided by an application program. The central method is used to store a configuration identifier for the user identifier, the configuration identifier being able to be used to carry out a configuration method.

### CROSS REFERENCE TO RELATED APPLICATIONS

This application is based on and hereby claims priority to German Application No. 101 49 977.9 filed on Oct. 10, 2001, the contents of which are hereby incorporated by reference.

### BACKGROUND OF THE INVENTION

The invention relates, inter alia, to a method for accessing user data which normally comprise a user identifier and application data. The user identifier denotes a user of an operating resource whose functions are provided by an application program. The application program accesses the application data when the functions of the operating resource are provided. Before the operating resource is used, however, the application data need to be matched to the user. In this context, reference is also made to configuration.

Normally, configuration is carried out using the application program itself. If a user uses a plurality of application programs, then mutually independent configuration methods need to be carried out. Configuration using the application program affords the advantage that changes to the configuration method can be made simultaneously with changes to the application program. The known method is therefore in widespread use.

### SUMMARY OF THE INVENTION

It is an object of the invention to provide an improved method for accessing user data which is simple and satisfies requirements of coherent changing of user data and consistency of the user data. This object may be achieved using a computer program executed by a data processing installation and accessing an associated data structure.

Within the context of the invention, coherent changing of data means that data stored multiple times in a computer network or on a computer can be changed from a plurality of locations and that the changes are made at all locations at which the data in question are stored. The requirement of consistency is satisfied when the data stored for a user do not conflict with other data stored for this user.

The invention is based on the consideration that it should be possible to allocate operating resource to particular users either using a specific application program or using a superordinate management program. The superordinate management program facilitates, in particular, the consistent deletion of user data which relate to a particular user, because it is able to ascertain all the operating resources associated with the user. By contrast, an application program has only a limited view of the operating resources, namely just of the operating resource whose functions it provides. On the other hand, the invention is alternatively based on the insight that, despite the use of a superordinate management program, the actual configuration of the application data should remain for specific configuration methods which, by way of example, are part of the application program.

The inventive method therefore involves using a central method to access a user identifier which denotes a user who is using or wishes to use an operating resource whose functions are provided by an application program. In addition, the central method is used to store a configuration identifier for the user identifier, so that the configuration identifier can be used to carry out a configuration method.

The configuration method is used to access application data which the application program reads or has read when the operating resource is used by the user. In addition, the inventive method has a central access type or a local access type which can be implemented as alternatives. The central access type involves the configuration method being carried out with the central method using the configuration identifier. The local access type involves the user identifier or the configuration identifier being made accessible to the central method, and being handled by the central method, when the configuration method is carried out.

Access means generation, allocation, configuration or deletion of data. The central method is thus used to allocate merely configuration identifiers, e.g. identifiers for a particular operating resource or references to the configuration methods or configuration programs associated with a particular operating resource, to a user identifier. For the central viewpoint, it is thus merely necessary for the operating resource to be allocated to a user identifier without the central method requiring details about the actual configuration. The actual configuration of the operating resource is performed by delegating the configuration from the central method to the specific configuration method.

The local access type involves first carrying out the configuration method. Next, the changes which have occurred are readjusted, for example automatically, with regard to the user identifiers and operating resource managed by the central method. Local changes are only forwarded if centrally stored data need to be changed. This practice is also referred to as the locality principle.

The inventive method facilitates, in particular, automatic deletion of a user's data or of parts of these data, because the central method automatically calls a plurality of configuration methods, which can be ascertained by the configuration identifiers, in succession. Other advantages of the inventive method will become clear from the rest of the explanations.

In one development of the invention, the central method is used to record at least one further configuration identifier for the user identifier or for another user identifier. The further configuration identifier is used in the central access type to start a further configuration method which is used for configuring another operating resource. The configuration identifier is thus used for distinguishing different configuration methods and different operating resources from one another.

In another development of the invention, access refers to a data read operation or a data write operation. Generation of data involves the execution of a write operation, for example. Configuring already existing data involves first executing a read operation in order to display the data which are read on a display unit. When the data have been changed, the changed data are written. To check the data, only a read operation can be executed, for example. In one refinement of the inventive method, access refers to a deletion operation. Data can be deleted, by way of example, by overwriting them with other data or else merely by removing references which are required for accessing the data.

In another development of the invention, the central method is carried out using a central program. The configuration method is carried out using a configuration program.

In a subsequent development, the central method and the configuration method are carried out on different computers in a data transmission network. Particularly in data transmission networks, it is specially important to keep user data consistent and to be able to change them coherently. Thus, data transmission networks often use “distributed systems”, in which the user data can be stored for a user distributed over several computers.

In one development of the invention, the operating resource is an Internet telephone, an e-mail box or a voice box. Particularly in the case of these applications, it is expedient for separate configuration methods to be carried out in each case and for the user data nevertheless to be managed from a central location as well.

In a subsequent development of the invention, the operating resource has an associated general data record which stipulates user-independent properties of the operating resource, for example a general indication about the type of operating resource, or about the representation of the operating resource when the central method is carried out, i.e. for details which facilitate the allocation of operating resources to particular users. In one refinement, this data record also includes the configuration identifier or parts of the configuration identifier.

In a subsequent development, the user identifier has an association reference data record which includes a reference to the general data record. Additionally or alternatively, the reference data record includes a reference to the application data. By moving particular data to the reference data record, a file in which all the users are registered needs to be changed only rarely, namely only when a new user is added or a user is removed. The file does not need to be changed, however, when an operating resource needs to be added for an already registered user or when an operating resource needs to be removed from a user.

In a subsequent development of the invention, the application data include user-dependent data, for example a call number for the user at which he can be reached in a circuit-switched network, or an Internet address at which he can be reached on the Internet. In refinements, the application data also includes references to the central method which allow the central method to be carried out automatically following the local configuration. This call can also be made such that an operator does not notice the call for carrying out the configuration method.

In another development, standard data are used as preset values when stipulating the user identifier or when stipulating the application data. Such preset values are also referred to as templates and significantly facilitate the input of data.

In another development of the invention, the user data, i.e. particularly the user identifier or the application data, are stored in a data description language. Data description languages afford the advantage that they can be read equally well by computers and people. Suitable languages are, by way of example, the languages Hypertext Markup Language (HTML) or Extensible Markup Language (XML). Other data formats can also be used, however, for example “records” or “structures”.

In a subsequent development of the invention, the method is provided when a Java program or a directory service is executed. Both options are particularly suitable for data transmission networks.

In a subsequent development of the invention, the configuration method is part of the application program. Alternatively, the configuration method is detached from the application program so that the configuration method can be better matched to the requirements of a data transmission network.

The invention also relates to a program whose execution by a processor involves carrying out at least the central method or the local method of the inventive method. The invention also relates to a data processing installation having such a program. In addition, the invention relates to a data structure which includes a user identifier and a configuration identifier which is associated with the user identifier and is used to carry out a configuration method. In developments of the data structure, the latter includes data accessed when the inventive method or a development is carried out. This means that the aforementioned technical effects likewise apply to the program, to the data processing installation and to the data structure.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of user data and programs for accessing the user data,

FIG. 2 is a block diagram showing relationship between classes of data structures used by the programs,

FIG. 3 is a state diagram for registration of a configuration program by a global user management program,

FIG. 4 is a state diagram of adding user data by a global manager,

FIG. 5 is a state diagram of adding user data by a configuration program,

FIG. 6 is a state diagram of removing user data by a global manager,

FIG. 7 is a state diagram of removing user data by a configuration program,

FIG. 8 is a state diagram of modifying user data by a global manager, and

FIG. 9 is a state diagram of modifying user data by a configuration program.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

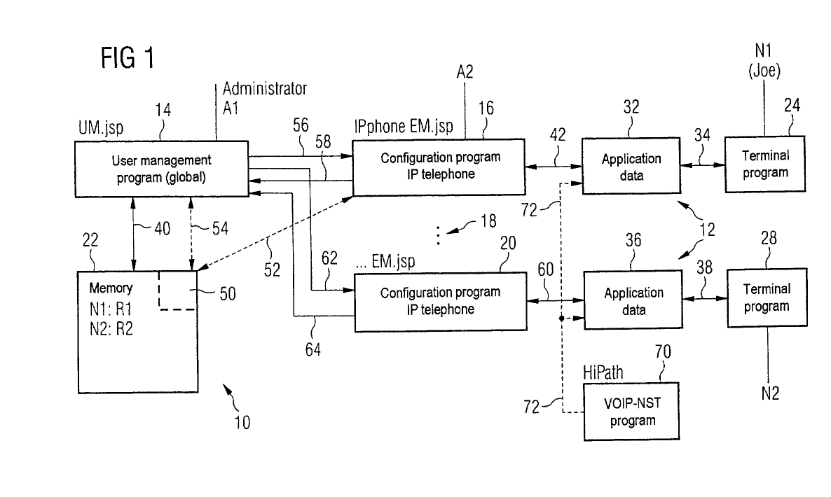

FIG. 1 shows user data 10 and 12 and a user management program 14 and configuration programs 16 to 20 which are used for accessing the user data 10 and 12. The user data 10 are stored in a memory unit 22, for example in a database. The memory unit 22 contains, for various users N1, N2, operating resource identifiers R1 and R2 which denote operating resources used by the respective users. The functions of the operating resource associated with the operating resource identifier R1 are provided by a terminal program 24. The terminal program 24 is used by a user N1. It will be assumed that the user N1 is called Joe.

An operating resource identifier R2 denotes an operating resource whose function is provided by a terminal program 28. The terminal program 28 is used by a user N2. The user data 10 for the respective users thus include the following data records:

N1: R1,

N2: R2.

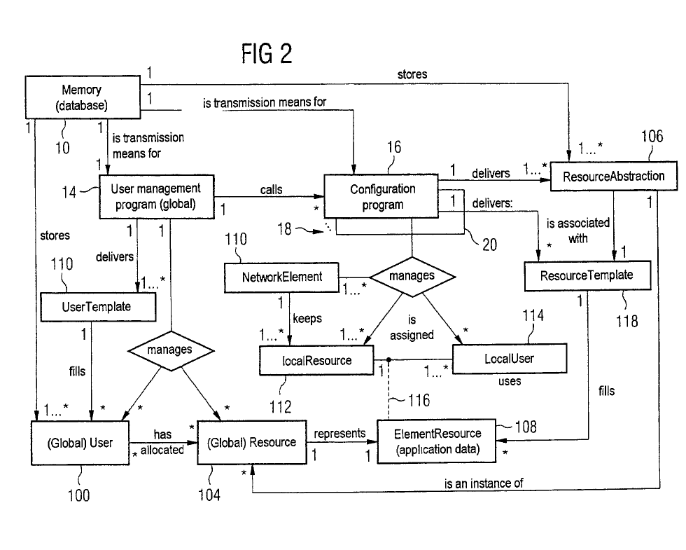

The user data thus record general associations between operating resources R1 and R2 and users N1, N2, with no details being indicated for the operating resources. Further data held in the user data 10 are explained below in connection with FIG. 2.

The user data 12 are divided into application data 32 for the terminal program 24, see arrow 34, and application data 36 for the terminal program 28, see arrow 38. The application data 32 are explained in more detail below in connection with FIG. 2. The application data 36 include details about how the IP telephone of the user N2 needs to be configured.

The user data 10 are managed by the user management program 14, see arrow 40. The method carried out by the user management program 14 in this context are explained below in connection with FIGS. 2 to 9. In the exemplary embodiment, the user management program 14 is provided using a “Java Server Page” asp) called UM.jsp, where UM is the abbreviation for User Management. The user management program 14 is used, by way of example, by a global system administrator A1.

The configuration program 16 is used for configuring IP telephones (Internet protocol) which are associated with the users N1, N2 and with other users. The configuration program 16 is used for generating and for deleting the application data 32, see arrow 42. The method carried out by the configuration program 16 are explained in more detail below in connection with FIGS. 2 to 9. In the exemplary embodiment, the configuration program 16 is produced using a Java server page (jsp) called IPphoneEM.jsp, where EM is an abbreviation for element manager. The configuration program 16 is started, by way of example, by an administrator A2. Between the user management program 14 and the configuration program 16, data about a part 50 of the memory unit 22 can be interchanged, cf. arrows 52 and 54. The user management program 14 and the configuration program 16 can call one another alternately, see arrows 56 and 58.

The configuration program 20 is used for managing the application data 36, see arrow 60. In the exemplary embodiment, the configuration program 20 is likewise produced using a Java server page (jsp). When a configuration program 20 is executed, a similar operation is carried out for the application data 36 as for the application data 32 when the configuration program 16 is executed. For this reason, the method carried out when the configuration program 20 is executed are not explained in more detail. Between the user management program 14 and the configuration program 20, data about the part 50 of the memory unit 10 can likewise be interchanged. In addition, the user management program 14 and the configuration program 20 can call one another, cf. arrows 62 and 64.

The application data 32 and 36 are also accessed by a VoIP private-branch program 70 which provides the functions of a private-branch exchange, for example call forwarding or switching from a central control station to the IP telephones connected to the private-branch exchange, for the VoIP (Voiceover Internet Protocol) service. The private-branch exchange is, by way of example, an installation of the type HiPath 3000, as manufactured by SIEMENS AG. Access to the application date 32 and 36 by the private-branch program 70 is shown by an arrow 72.

FIG. 2 shows the relationships between classes of data structures which are used by the user management program 14 and by the configuration program 16 for the purpose of accessing the user data 10 and 12. The representation of the classes shown in FIG. 2 concurs with the stipulations of a Unified Modeling Language (UML) which has been defined by the Object Management Group (OMG) as described at their website. In this language, the classes are represented by rectangles. Relationships between just two classes are represented by arrows. To represent relationships involving more than two classes, diamonds are used. In addition, identifiers indicating the number of instances of the respective class are shown at the ends of the arrows. Thus, the digit 1 denotes a single instance. The character “*” denotes any number of instances. The identifier “1 . . . *” indicates that there needs to be at least one instance. The identifiers are each in the immediate vicinity of the rectangle for the class for which they define the number of instances. In addition, verbal details associated with the arrows indicate the relationships in more detail.

A User class 100 defines the composition of data structures for a user from a central viewpoint. By way of example, instances of the User class 100 respectively include the name of the user, the name of the company which employs the user and a reference to a file which indicates the operating resource associated with the user.

An instance of the User class 100 has, by way of example, the following composition:

umhost.de/UM.jsp

<UMUserList>

<User

name = “joeuser@umhost.de
company = “Siemens”
resources = “joeuser.resources.xml”>

</User>

</UMUserList>

where “umhost.de” denotes the computer on which the user management program 14 is executed. The designation “UM.jsp” is, as already mentioned, the name of the user management program itself. A data structure UMUserList includes the instances of User class 100, the exemplary embodiment above showing only one instance, namely an instance for the user N1. The name indicated for the user N1 is his Internet address joeuser@umhost.de. The company indicated is “Siemens”. The file in which the operating resources are listed is called “joeuser.resources.xml” in the exemplary embodiment. The content of this file is explained in more detail further below.

A UserTemplate class 102 defines the composition of data structures which are used for prescribing preset values for instances of the User class 100. By way of example, an instance of the UserTemplate class 102 has the following composition:

<UserTemplate

company = “Siemens”>

<UserTemplate>

where the preset prescribed for the data field for denoting the company is “Siemens”. Other instances of the UserTemplate class 102 define other companies or else other preset values. The instance to be used is respectively selected manually when setting up the data for a user. The instance of the UserTemplate class 102 is likewise stored on the computer having the address “umhost.de”.

A resource class 104 defines the composition of reference data records which comprise, by way of example, a reference to a general description of an operating resource and a reference to a file containing the application data. By way of example, a reference data record has the following composition:

“umhost.de/resources/joeuser.resources.xml”

<ResourcesList>

<Resource

ResourceAbstraction = IPphoneAbstraction.xml”
ElementResource =
“emhost.de/element.resources/joeuser.phone.xml”>

</Resource>

<ResourceList>

where “umhost.de/resources/joeuser.resources.xml” indicate the memory location and the name of the file mentioned in connection with User class 100 for listing the operating resource. A data structure “ResourceList” includes a plurality of resource data structures, with one resource data structure being shown in the exemplary embodiment. Each instance of the resource class respectively includes a data field “ResourceAbstraction”, which refers in the exemplary embodiment to a file name “IPphoneAbstraction.xml”, and a data field “ElementResource”, which refers to the application data. In the exemplary embodiment, the application data are stored under “emhost.de/element.resources.joeuser.phone.xml”, i.e. on a computer having the address EMhost.de in a directory “element.resources”. The computer having the address “EMhost.de” is the same computer as that on which the configuration program 16 is executed. The content of both files is explained in more detail below. The file for storing the application data is called “joeuser.phone.xml”, where the “joeuser” part concurs with a part of the user identifier. The “phone” part corresponds to the operating resource identifier R1.

A ResourceAbstraction class 106 defines the composition of data structures which give a general description of the operating resource. An exemplary embodiment of an instance of the ResourceAbstraction class 106 has the following content:

“umhost.de/abstraction/PphoneAbstraction.xml”

<ResourceAbstraction

type = “IPphone”

| | |
|---|---|
| EMhost | = “emhost.de” |
| ElementManager | = “IPphoneEM.jsp” |
| template | = “templates/IPphone.template.xml” |
| icon | = “icons/IPphone.jpg”> |

<ResourceAbstraction>

where “umhost.de/abstraction.IPphoneAbstraction.xml” denotes the name and storage location of the file “IPphoneAbstraction.xml”, i.e. the file containing the general details about the operating resource. The instance of the ResourceAbstraction class 106 which is illustrated in the exemplary embodiment includes the following data fields:

a type field “type” for indicating the type of operating resource, for example an IP telephone,

a “host identifier” “Emhost” for indicating the computer on which the configuration program 16 is executed, e.g. the computer having the address “emhost.de”,

a data field “Elementmanager”, which indicates the name of the configuration program 16, e.g. IPphoneEM.jsp,

a data field “Template”, which indicates a reference to a data structure storing preset values for the application data, e.g. Template/IPphone.template.xml”, whose content is explained in more detail below, and

a data field “Icon” for indicating an image file whose data is used for representing the operating resource on a user interface in the user management program 14, e.g. the image file “icon/IPphone.jpg”.

The data fields “EMhost” and “Elementmanager” mentioned in the listing form a configuration identifier which can be used to call the configuration program 16 from the user management program 14.

The data values contained in the instance of the ResourceAbstraction class 106 have been transmitted from a configuration program 16 to the user management program 14 using the part 50 of the memory unit 22.

An ElementResource class 108 defines the composition of the application data. By way of example, the application data generated for the user N1 have the following data fields:

emhost.de/IPphoneEM.jsp
“emhost.de/element.resources/joeuser.phone.xml”

<ElementResource>

<IPphone

| | |
|---|---|
| gateway | = “123.111.22.10” |
| telno | = “1234” |
| user | = “joeuser@emhost.de” |
| ipAdr | = “123.103.29.29” |
| UMhost | = “umhost.de” |
| UMuser | = “joeuser” |
| UMappl | = “UM.jsp”> |

<IPphone>

</ElementResource>

where the application data are stored in the “emhost.de/element.resources/joeuser.phone.xml” file mentioned above. The application data relate to an IP telephone which can be configured by the contents of the data fields in a data structure “IPphone”.

The data structure “lpphone” includes the following data fields:

a data field “Gateway” for indicating the Internet address which the Internet telephone of the user N1 can use to access the Internet—in the exemplary embodiment, the address “123.111.22.10” defined using a preset data record, which is explained in more detail further below,

a data field “telno” for indicating a telephone number on which the user N1 can be reached in the telephone network, e.g. the number “1234”,

a data field “user” for indicating a local identifier for the user N1, e.g. the indentifier joeuser@emhost.de, which concurs with the global user identifier for the user N1,

a data field “ipAdr” for indicating the Internet address at which the user N1 can be reached by telephone, e.g. the Internet address “123.103.29.29”,

a data field “UMhost” for indicating the computer on which the user management program 14 is executed—in the exemplary embodiment, the computer having the address “umhost.de”,

a data field “UMuser” for indicating the central or global name for the user N1, for example the name “joeuser”, which concurs with the specific or local name in the exemplary embodiment, and

a data field “UMAppl” for indicating the program name for the user management program 14, for example the name “UM.jsp”.

A NetworkElement class 110 defines the composition of data structures which respectively describe an element of the operating resource Network, e.g. a private-branch exchange. An instance of the NetworkElement class 110 which is held in the file “joeuser.phone.xml” has, by way of example, the following composition:

<NetworkElement>

<VolP-Switch>
</VolP-Switch.

</NetworkElement>

where VoIP-Switch is a wildcard for a large amount of data for describing and configuring the private-branch program 70.

A localResource class 112 defines the composition of data structures describing the locally used resources or operating resources. In the exemplary embodiment, the instance of the localResource class 112 for the user N1 includes the following data item:

<localResource

adr = “123.103.29.29”>

<localResource>

where the numerical sequence “123.103.29.29” is the Internet address of the local operating resource which is used by the user N1.

A localUser class 114 defines the composition of data structures for describing the users. For the user N1, the following applies:

<localUser

account = “joeuser”

name = “Joe N. User”>
</localUser>

where a data field “account” indicates the local user identifier, e.g. “joeuser”, and a data field “Name” indicates the user's civil name, for example Joe N. User.

The instances of the NetworkElement class 110, of the localResource class 112 and of the localUser class 114 are stored on the computer having the address “emhost.de”, preferably in the file “IPphoneEM.jsp”.

A dashed line 116 illustrates this relationship particularly for the application data in the instance of the ElementResource class 108 and for the instance of the data structure localResource class 112.

A ResourceTemplate class 118 defines the composition of data structures for prescribing preset values for the application data. In the exemplary embodiment, an instance of the ResourceTemplate class 118 includes the following data:

“emhost.de/template.IPphone.template.xml”

<ResourceTemplate>

<IPphone

gateway = “123.111.22.10”>

</IPphone>

</ResourceTemplate>

where “emhost.de/template/IPphone.template.xml” denotes the storage location of the instance. In the exemplary embodiment, the template prescribes only the Internet address for Internet access which the user N1 can use to access the Internet.

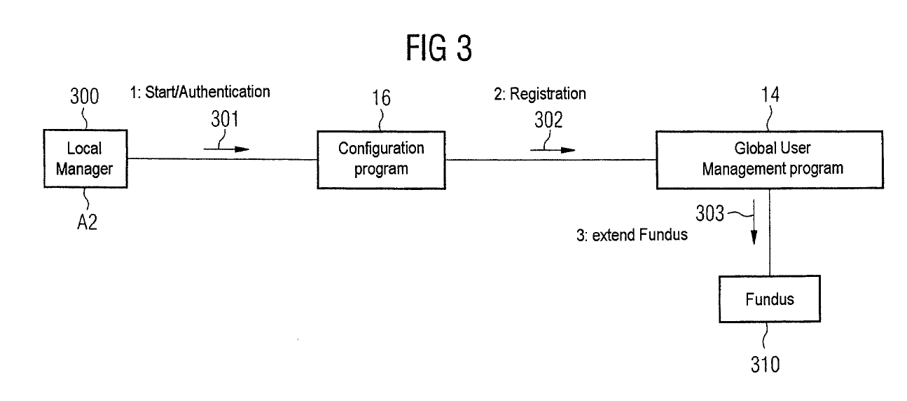

FIG. 3 is a state diagram illustrating a method for registering the configuration program 16 with the user management program 14. FIGS. 3 to 9 utilize UML.

In state transition 301, the local administrator A2 starts the configuration program 16 and identifies himself for an authentication method by inputting a password. In state transition 302, the administrator A2 prompts registration of the configuration program 16 with the user management program 14. This involves transmitting the data for the instance of the class ResourceAbstraction class 106 which belongs to the configuration program.

In state transition 303, the user management program 14 stores the transmitted data in a Fundus 310, which is likewise held in the memory unit 10, for example.

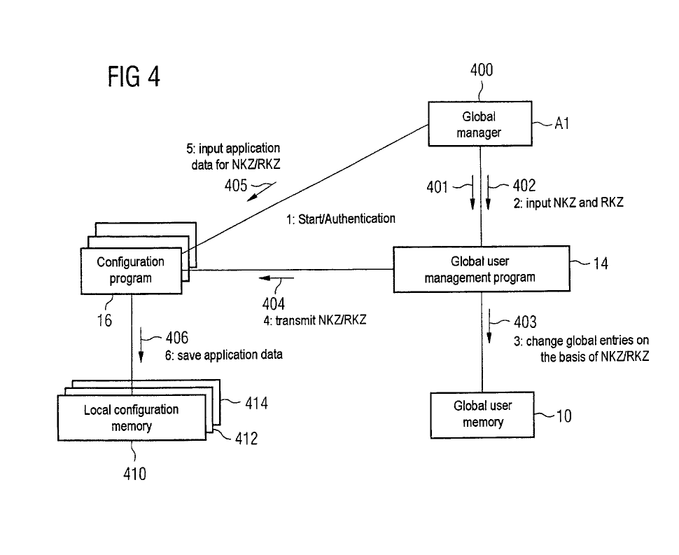

FIG. 4 is a state diagram illustrating a method for adding user data with the central method carried out using the user management program 14.

In state transition 401, the administrator A1 starts the user management program 14 and identifies himself for an authentication method using a password. In state transition 402, the administrator A1 inputs a user identifier NKZ, e.g. the user identifier of the user N1, and an operating resource identifier RKZ, e.g. the operating resource identifier R1.

In a subsequent state transition 403, the data NKZ and RKZ which have been input are stored in the memory unit 22. In the exemplary embodiment, the operating resource R1 is recorded for the user N1 in the user data 10, see also FIG. 1.

In a subsequent state transition 404, the user management program 14 transmits the user identifier NKZ and the operating resource identifier RKZ to the configuration program 16.

Next, the administrator A1 inputs the application data for the user denoted by the user identifier NKZ, e.g. for the user N1, and for the operating resource denoted by the operating resource identifier RKZ, e.g. for the operating resource R1. The administrator A1 inputs the data using the configuration program 16, which he can access via a data transmission network. In this regard, the user management program 14 evaluates the data field “ElementManager” in the ResourceAbstraction data structure to ascertain the Java server page which can be used to call the configuration program 16. In addition, the data field “EMhost” is evaluated to ascertain the address of the computer on which the configuration program 16 is stored.

In state transition 406, the configuration program 16 stores the application data which have been input by the administrator A1 in a local configuration memory 410, see application data 32 in FIG. 1. For other configuration programs 18, 20, there are further local configuration memories 412 and 414.

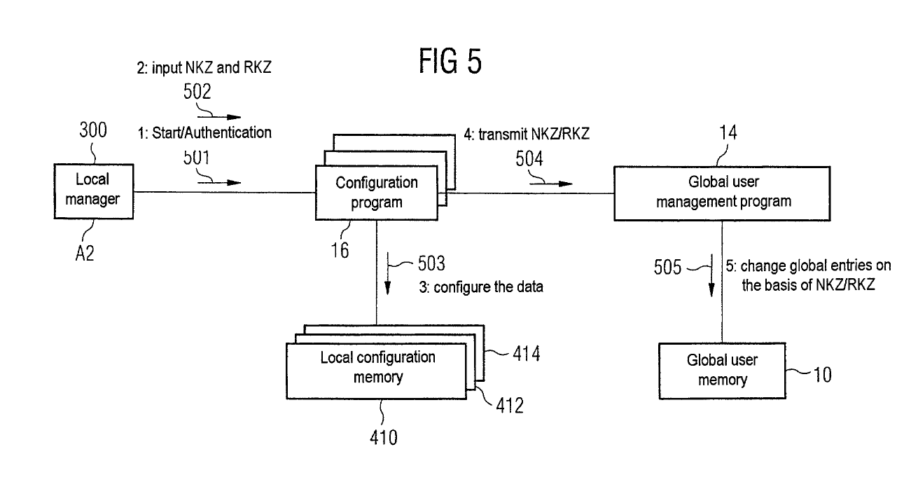

FIG. 5 is a state diagram of a method for adding user data from the configuration program 16. In state transition 501, the administrator A2 starts the configuration program 16 and identifies himself for an authentication method or for authentication using a password. It will be assumed that the password is correct.

In a subsequent state transition 502, the administrator A2 inputs a user identifier NKZ for a user to whom he wishes to allocate an operating resource. In addition, in state transition 502, the administrator A2 inputs an operating resource identifier RKZ which denotes the operating resource which is to be allocated to the user.

In state transition 503, the administrator A2 uses the configuration program 16 to configure the application data. The application data are stored in the local configuration memory 410.

In a subsequent state transition 504, the configuration program 16 automatically conveys the user identifier NKZ and the operating resource identifier RKZ to the user management program 14 via the data transmission network.

Following receipt of the user identifier NKZ and of the operating resource identifier RKZ, the user management program 14 stores the received data in the memory unit 22 as user data 10, with the instance of the ResourceAbstraction class 160 also being used for the configuration program 16.

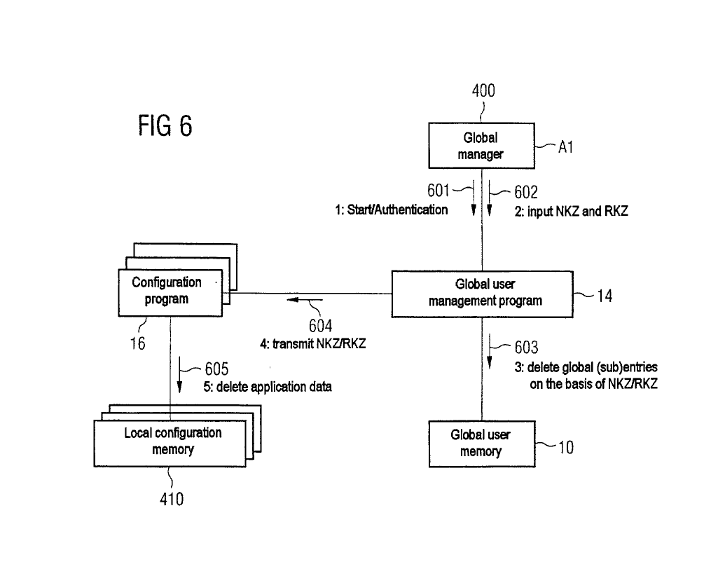

FIG. 6 is a state diagram of a method for removing user data from the central method. In state transition 601, the administrator A1 starts the user management program 14. He inputs his password and is authenticated.

In state transition 602, the administrator A1 uses the user management program 14 to input a user identifier NKZ and an operating resource identifier RKZ which denote the user whose operating resource is to be deleted and the operating resource itself.

In state transition 603, the user management program 14 prompts the operating resource having the operating resource identifier RKZ, which operating resource is associated with the user having the user identifier NKZ, to be deleted in the user data 10. To this end, the memory unit 22 is accessed by the user management program 14.

In a subsequent state transition 604, the user management program 14 automatically transmits the user identifier NKZ, which was input in state transition 602, and the operating resource identifier RKZ, which was likewise input in state transition 602, to the configuration program 16 via the data transmission network. To call the configuration program 16, the address data explained above are used.

In state transition 605, the configuration program 16 receives the user identifier NKZ and the operating resource identifier RKZ and deletes entries in the application data on the basis of these stipulations. The data are deleted in the local configuration memory 410.

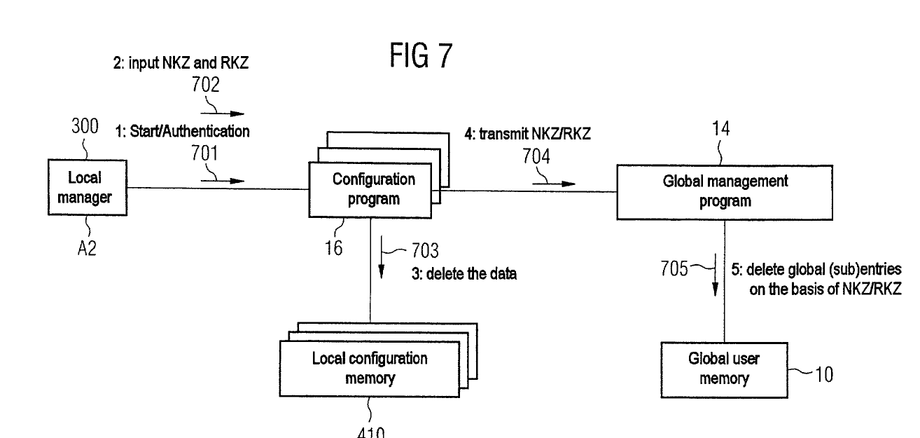

FIG. 7 is a state diagram of a method for removing user data from the configuration program 16. In state transition 701, the administrator A2 starts the configuration program 16 and identifies himself when carrying out an authentication method.

In state transition 702, the administrator A2 uses the configuration program 16 to input a user identifier NKZ for a user for whom an associated operating resource is to be removed. In state transition 702, an operating resource identifier RKZ which is to be input is also used to denote the operating resource which is no longer intended to be available to the user.

In state transition 703, the configuration program 16 prompts deletion of the association for the operating resource having the operating resource identifier RKZ, which operating resource is associated with the user having the user identifier NKZ which was input in state transition 702. The association is deleted in the local configuration memory 410.

In a subsequent state transition 704, the configuration program 16 automatically transmits the user identifier NKZ, which was input in state transition 702, and the operating resource identifier RKZ, which was likewise input in state transition 702, to the user management program 14. The user identifier NKZ and the operating resource identifier RKZ are transmitted via the data transmission network. The configuration program 16 ascertains the address of the user management program 14 using the application data explained above.

Following receipt of the user identifier NKZ and of the operating resource identifier RKZ, the user management program 14 deletes the association between the operating resource identifier RKZ and the user denoted by the user identifier NKZ in the memory unit 22 in state transition 705.

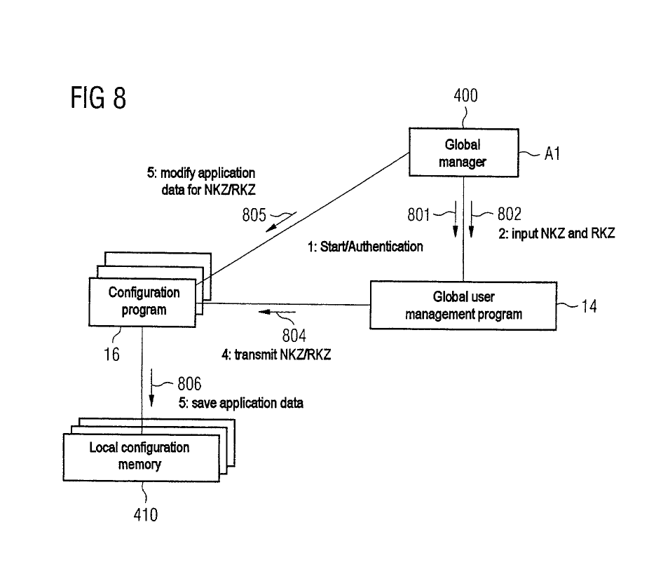

FIG. 8 is a state diagram of a method for modifying entries from the central method. In state transition 801, the administrator A1 starts the user management program 14 and identifies himself using a password. It will be assumed that the password is correct.

In a subsequent state transition 802, the administrator A1 uses the user management program 14 to input a user identifier NKZ and an operating resource identifier RKZ, so that a user is denoted for whom an already allocated operating resource needs to be reconfigured.

If already existing entries are being modified, no user data need to be changed in the memory unit 22. The user management program 14 thus also does not access the memory unit 22.

In a subsequent state transition 804, the user management program 14 transmits the user identifier NKZ, which was input in state transition 802, and the operating resource identifier RKZ, which was likewise input in state transition 802, to the configuration program 16 via the data transmission network.

The configuration program 16 is started automatically and the data transmission network is used to set up a connection between the administrator A1 and the configuration program 16. The application data already stored for the user and for the operating resource in the configuration memory 410 are read and are transmitted to the administrator A1 via the data transmission network. In state transition 805, the administrator A1 also uses the connection to modify the application data for the operating resource RKZ, which was denoted in state transition 802 and is associated with the user NKZ denoted in state transition 802.

In a subsequent state transition 806, the configuration program 16 stores the changed application data in the local configuration memory 410.

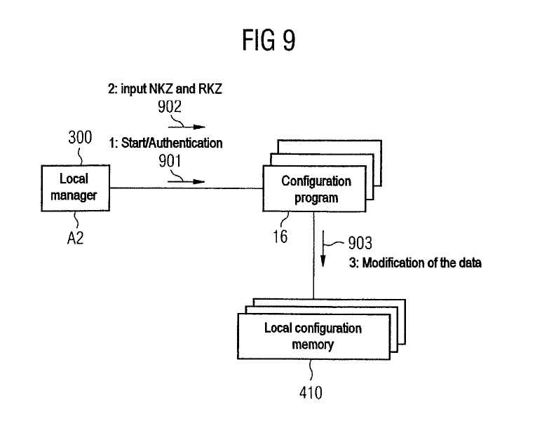

FIG. 9 is a state diagram of a method for modifying entries using the configuration program 16. In state transition 901, the administrator A2 starts the configuration program 16. In addition, the administrator A2 is automatically authenticated, for example using a password.

In a subsequent state transition 902, the administrator A2 uses the configuration program 16 to input a user identifier NKZ for a user whose application data need to be changed. In addition, in state transition 902, the administrator A1 inputs an operating resource identifier RKZ which denotes an operating resource associated with the user having the user identifier NKZ.

In state transition 903, the application data from the configuration program 16 which are to be changed are read from the configuration memory 410 and are output or displayed. The administrator A2 modifies the application data associated with the operating resource using the configuration program 16. The changed application data are likewise stored in state transition 903 in the local configuration memory 410 using the configuration program.

If already existing entries are just changed, then the user management program 14 does not need to be informed about the change, since the user data stored in the memory unit 22 can remain unchanged.

In another exemplary embodiment, an operating resource is allocated to a plurality of users. This means that the terminal program 24 can be allocated to the user N1 in the morning and to a user N3 in the afternoon, for example. The allocation of the operating resource to users over time is recorded in the application data. Otherwise, the methods for accessing the user data 10 and 12 explained with reference to FIGS. 1 to 9 remain unchanged. This is made possible by the classes prescribed with reference to FIG. 2.

The invention has been described in detail with particular reference to preferred embodiments thereof and examples, but it will be understood that variations and modifications can be effected within the spirit and scope of the invention.

What is claimed is:

1. A method for accessing user data, comprising:
accessing a user identifier denoting a user by a central method in response to at least one of use of and a request to use an operating resource having a function produced by an application program;
storing a configuration identifier for the user identifier by the central method, the configuration identifier being usable in a configuration method to access application data read by the application program when the operating resource is used by the user; and
configuring the operating resource by one of
a central access type where the configuration method is carried out using the configuration identifier when the central method is carried out, and
a local access type where at least one of the user identifier and an operating resource identifier denoting the operating resource are transmitted to a unit for the purpose of carrying out the configuration method by the unit and passing the at least one of the user identifier and the operating resource identifier to the central method.

2. The method as claimed in claim 1, wherein the central method is used to record at least one further configuration identifier for at least one of the user identifier and another user identifier, the further configuration identifier being usable to start a further configuration method for configuring another operating resource.

3. The method as claimed in claim 2, wherein said accessing includes at least one of a read operation, a write operation, and a deletion operation.

4. The method as claimed in claim 3,
wherein the central method is carried out using a central program, and
wherein the configuration method is carried out using a configuration program.

5. The method as claimed in claim 4, wherein the central method and the configuration method are carried out on different computers in a data transmission network.

6. The method as claimed claim 5, wherein the operating resource is one of an Internet telephone, an e-mail box and a voice box.

7. The method as claimed claim 6, further comprising storing an associated general data record for the operating resource to at least one of stipulate user-independent properties of the operating resource, define a data item indicating a type of operating resource, provide an address of the computer used to carry out the configuration method, provide at least part of the configuration identifier, provide a reference to standard data used when stipulating the user identifiers, and provide one of an image file and a reference to the image file used to represent the operating resource.

8. The method as claimed in claim 7, wherein the user identifier has an associated reference data record including at least one of a reference to the general data record and a reference to the application data.

9. The method as claimed in claim 8, wherein the application data at least one of include user-dependent data, denote a network access unit to provide the user with access to a data transmission network, define a call number used to reach the user in a circuit-switched telephone network, include a local user identifier for the user matching at least part of the user identifier, include an address in a data transmission network at which the user can be reached on the Internet, include an address of a computer which is used for calling the central method, include at least part of the user identifier, and include a start identifier used for starting the central method.

10. The method as claimed in claim 9, wherein standard data are used as preset values at least one of when stipulating the user identifier and when stipulating the application data.

11. The method as claimed in claim 10, wherein at least part of the user data are stored in a data description language.

12. The method as claimed in claim 11, wherein at least one of the central method and the configuration method are performed when one of a Java program and a directory service is executed.

13. The method as claimed in claim 12, wherein the configuration method is one of part of the application program and separate from the application program.

14. At least one computer readable medium storing at least one program for controlling a processor to perform a method for accessing user data, comprising:
accessing a user identifier denoting a user by a central method in response to at least one of use of and a request to use an operating resource having a function produced by an application program;
storing a configuration identifier for the user identifier by the central method, the configuration identifier being usable in a configuration method to access application data read by the application program when the operating resource is used by the user; and
configuring the operating resource by one of
a central access type where the configuration method is carried out using the configuration identifier when the central method is carried out, and
a local access type where at least one of the user identifier and an operating resource identifier denoting the operating resource are transmitted to a unit for the purpose of carrying out the configuration method by the unit and passing the at least one of the user identifier and the operating resource identifier to the central method.

15. A data processing installation, comprising:
a storage unit to store a user identifier denoting a user and a configuration identifier for the user identifier by a central method, the configuration identifier being usable in a configuration method to access application data read by the application program when the operating resource is used by the user; and
at least one processor, coupled to said storage unit, to access the user identifier denoting the user by the central method in response to at least one of use of and a request to use an operating resource having a function produced by an application program, to configure the operating resource by one of
a central access type where the configuration method is carried out using the configuration identifier when the central method is carried out, and
a local access type where at least one of the user identifier and an operating resource identifier denoting the operating resource are transmitted to a unit for the purpose of carrying out the configuration method by the unit and passing the at least one of the user identifier and the operating resource identifier to the central method.

16. At least one computer readable medium storing a data structure comprising:
a user identifier denoting a user who is using or wishes to use an operating resource having a function is provided by an application program; and
a configuration identifier associated with the user identifier and usable in carrying out a configuration method to configure application data.

17. The least one computer readable medium as claimed in claim 16, further storing at least one program for controlling a processor to perform a method for accessing user data, comprising:
accessing the user identifier by a central method in response to at least one of use of and a request to use an operating resource having a function produced by an application program;
storing the configuration identifier for the user identifier by the central method, the configuration identifier being usable in a configuration method to access application data read by the application program when the operating resource is used by the user; and
configuring the operating resource by one of
a central access type where the configuration method is carried out using the configuration identifier when the central method is carried out, and
a local access type where at least one of the user identifier and an operating resource identifier denoting the operating resource are transmitted to a unit for the purpose of carrying out the configuration method by the unit and passing the at least one of the user identifier and the operating resource identifier to the central method.

18. At least one computer readable medium storing a data structure comprising:
a user identifier denoting a user who is using or wishes to use an operating resource having a function provided by an application program; and
a reference identifier associated with the user identifier and usable in carrying out a central method which records, for the user identifier, a configuration identifier for calling a configuration method.

19. The least one computer readable medium as claimed in claim 18, further storing at least one program for controlling a processor to perform a method for accessing user data, comprising:
accessing the user identifier by a central method in response to at least one of use of and a request to use an operating resource having a function produced by an application program;
storing the configuration identifier for the user identifier by the central method, the configuration identifier being usable in a configuration method to access application data read by the application program when the operating resource is used by the user; and
configuring the operating resource by one of
a central access type where the configuration method is carried out using the configuration identifier when the central method is carried out, and
a local access type where at least one of the user identifier and an operating resource identifier denoting the operating resource are transmitted to a unit for the purpose of carrying out the configuration method by the unit and passing the at least one of the user identifier and the operating resource identifier to the central method.
